(19) United States
(12) Patent Application Publication
(10) Pub. No.: US 2026/0003130 A1
(43) Pub. Date: Jan. 1, 2026

(54) OPTICAL FIBER ARRAY AND A NANOIMPRINT LITHOGRAPHY PROCESS FOR FORMING THE SAME

(71) Applicant: Himax Technologies Limited, Tainan City (TW)

(72) Inventors: Shi-Jen Wu, Tainan City (TW); Yin-Tung Lu, Tainan City (TW); Shu-Hao Hsu, Tainan City (TW); Teng-Te Huang, Tainan City (TW)

(21) Appl. No.: 19/319,310

(22) Filed: Sep. 4, 2025

Related U.S. Application Data
(62) Division of application No. 18/371,249, filed on Sep. 21, 2023.

(51) Int. Cl. G02B 6/36; G02B 6/38

(52) U.S. Cl. CPC G02B 6/3636; G02B 6/3839

(57) ABSTRACT

An optical fiber array includes a groove plate having a plurality of grooves disposed on a top surface thereof; and an optical component plate having a plurality of first optical components disposed on a first surface of the optical component plate and a plurality of second optical components disposed on a second surface of the optical component plate, the second surface being opposite the first surface.

### CROSS-REFERENCE TO RELATED APPLICATIONS

This application is a divisional application of U.S. application Ser. No. 18/371,249, filed on Sep. 21, 2023, the entire contents of which are hereby expressly incorporated by reference.

### BACKGROUND OF THE INVENTION

### 1. Field of the Invention

The present invention generally relates to an optical splitter package, and more particularly to an optical fiber array formed by nanoimprint lithography (NIL) process.

### 2. Description of Related Art

A optical splitter package, also known as fiber-optic splitter or beam splitter, is based on a quartz substrate of an integrated waveguide optical power distribution device, similar to a coaxial cable transmission system. The optical network system uses an optical signal coupled to the branch distribution. The fiber optic splitter is one of the most important passive devices in the optical fiber link. It is an optical fiber tandem device with many input and output terminals, especially applicable to a passive optical network (EPON, GPON, BPON, FTTX, FTTH etc.) to connect the main distribution frame and the terminal equipment and to branch the optical signal.

The optical fiber array is one component of the optical splitter package. There are many limitations in current production process for making the optical fiber array. The main limitation is that the UV light for adhesive curing cannot be applied from the bottom side of the V-groove. Another important limitation is the larger coefficient of thermal expansion (CTE) mismatch of silicon with other fiber array material. The V-groove is conventionally performed by machining with V-shaped diamond wheel. However, surface roughness sometimes limits the usage of the technique. The V-groove may be alternatively performed by conventional precision plastic molding. However, the optical and mechanical performances of the final products are mostly determined by shrinkage during molding, surface structure and accuracy of the product.

A need has thus arisen to propose a novel scheme to overcome drawbacks of conventional methods of making an optical fiber array.

### SUMMARY OF THE INVENTION

In view of the foregoing, it is an object of the embodiment of the present invention to provide an optical fiber array made by using nanoimprint lithography (NIL) process, with high precision pattern transfer with smooth surface, with optical grade material with high transmission optical performance, and suitable of mass production.

According to one embodiment, an optical fiber array includes a groove plate and an optical component plate. The groove plate has a plurality of grooves disposed on a top surface thereof. The optical component plate has a plurality of first optical components disposed on a first surface of the optical component plate and a plurality of second optical components disposed on a second surface of the optical component plate, the second surface being opposite the first surface.

According to another embodiment, a nanoimprint lithography (NIL) process for forming an optical fiber array includes the following steps: (a) providing a first wafer; (b) forming a first imprint resist layer on the first wafer; (c) subjecting the first imprint resist layer to imprinting by a groove working template, thereby resulting in a groove plate having a plurality of grooves disposed on a top surface thereof; (d) providing a second wafer; (e) forming a second imprint resist layer on a first surface of the second wafer; (f) subjecting the second imprint resist layer to imprinting by a first optical component working template, thereby resulting in a plurality of first optical components disposed on a first surface of an optical component plate; (g) inverting the second wafer, which is temporarily bonded to a support; (h) forming a third imprint resist layer on a second surface of the second wafer, the second surface being opposite the first surface; and (i) subjecting the third imprint resist layer to imprinting by a second optical component working template, thereby resulting in a plurality of second optical components disposed on a second surface of the optical component plate.

### BRIEF DESCRIPTION OF THE DRAWINGS

FIG. 1 shows a perspective view illustrating an optical splitter package;

FIG. 2A shows a perspective view illustrating an optical fiber array according to one embodiment of the present invention;

FIG. 2B shows a top view illustrating the optical fiber array of FIG. 2A;

FIG. 2C shows an exploded view illustrating the optical fiber array of FIG. 2A;

FIG. 3A to FIG. 3B show cross-sectional views illustrating a flow of forming the V-groove plate by using nanoimprint lithography (NIL) process according to one embodiment of the present invention; and

FIG. 4A to FIG. 4E show cross-sectional views illustrating a flow of forming the optical component plate by using nanoimprint lithography (NIL) process according to one embodiment of the present invention.

### DETAILED DESCRIPTION OF THE INVENTION

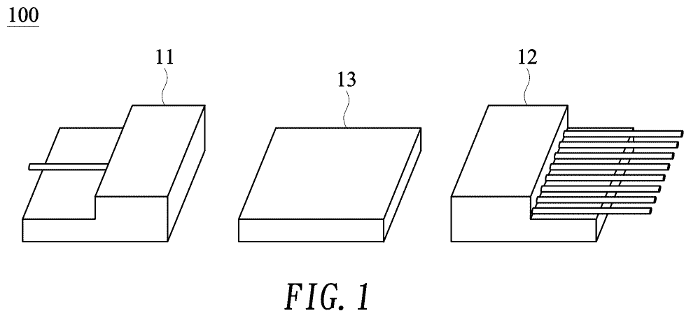

FIG. 1 shows a perspective view illustrating an optical splitter package 100. Specifically, the optical splitter package 100 may include an input part 11 configured to accommodate a single (optical) fiber, an optical fiber array 12 (as an output part) configured to accommodate multiple fibers, and a splitter 13 bonded between the input part 11 and the optical fiber array 12.

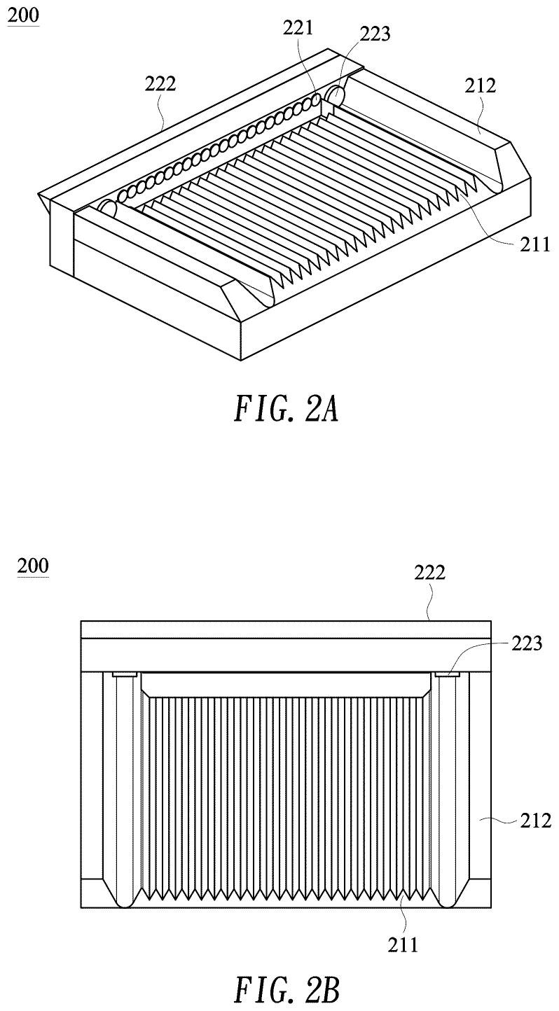

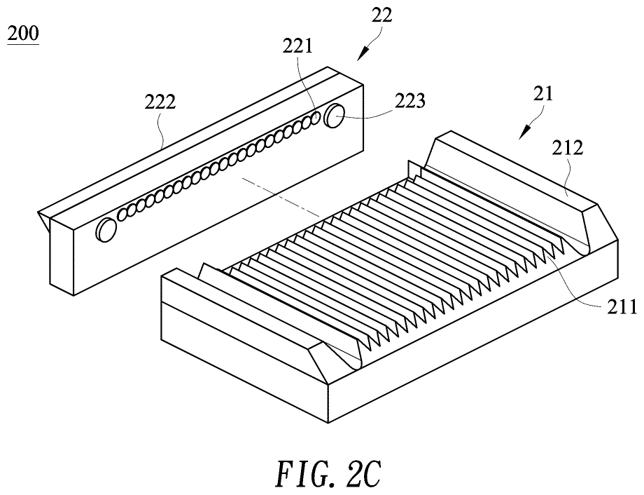

FIG. 2A shows a perspective view illustrating an optical fiber array 200 according to one embodiment of the present invention, FIG. 2B shows a top view illustrating the optical fiber array 200 of FIG. 2A, and FIG. 2C shows an exploded view illustrating the optical fiber array 200 of FIG. 2A.

In the embodiment, the optical fiber array 200 may include a V-groove plate 21. Specifically, the V-groove plate 21 may have a plurality of grooves 211 disposed on a top surface (of the V-groove plate 21), and the cross-sectional profile of each groove 211 resembles a V. In one embodiment, the V-groove plate 21 may have two protrusions 212 disposed longitudinally at both ends of the V-groove plate 21, and the protrusion 212 are higher than a top end of the grooves 211.

In the embodiment, the optical fiber array 200 may have an optical component plate 22. In the embodiment, a top surface of the optical component plate 22 is aligned with a top surface of the protrusions 212. The optical component plate 22 may have a plurality of first optical components such as lens 221 disposed on a first (front) surface of the optical component plate 22, the first surface facing the groves 211 of the V-groove plate 21. The optical component plate 22 may have a plurality of second optical components such as prisms 222 disposed on a second (back) surface of the optical component plate 22, the second surface being opposite the first surface. The optical component plate 22 may have at least two guide pins 223 disposed at both ends of the lens 221 (on the first surface of the optical component plate 22). The guide pins 223 in combination with the protrusions 212 may be used for performing alignment procedure. In one embodiment, a top surface of the protrusions 212

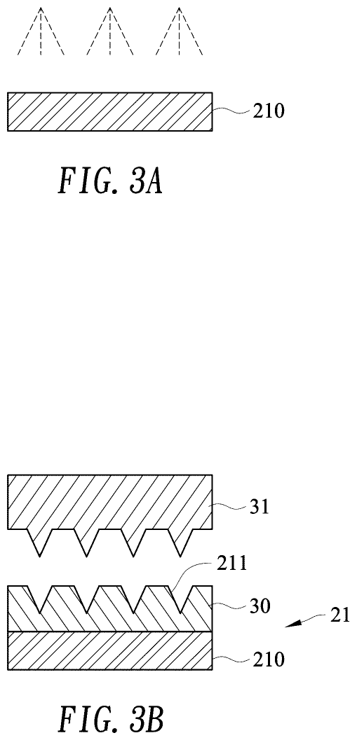

FIG. 3A to FIG. 3B show cross-sectional views illustrating a flow of forming the V-groove plate 21 by using nanoimprint lithography (NIL) process according to one embodiment of the present invention. As shown in FIG. 3A, a (first) wafer 210 (e.g., glass) is provided and is then subjected to cleaning. Next, as shown in FIG. 3B, a (first) imprint resist layer 30 (e.g., monomer or polymer) is formed on the (first) wafer 210, and is then subject to imprinting by a V-groove working stamp (or template) 31, thereby resulting in the grooves 211. The (first) imprint resist layer 30 may be cured by heat or (ultraviolet) UV light during the imprinting.

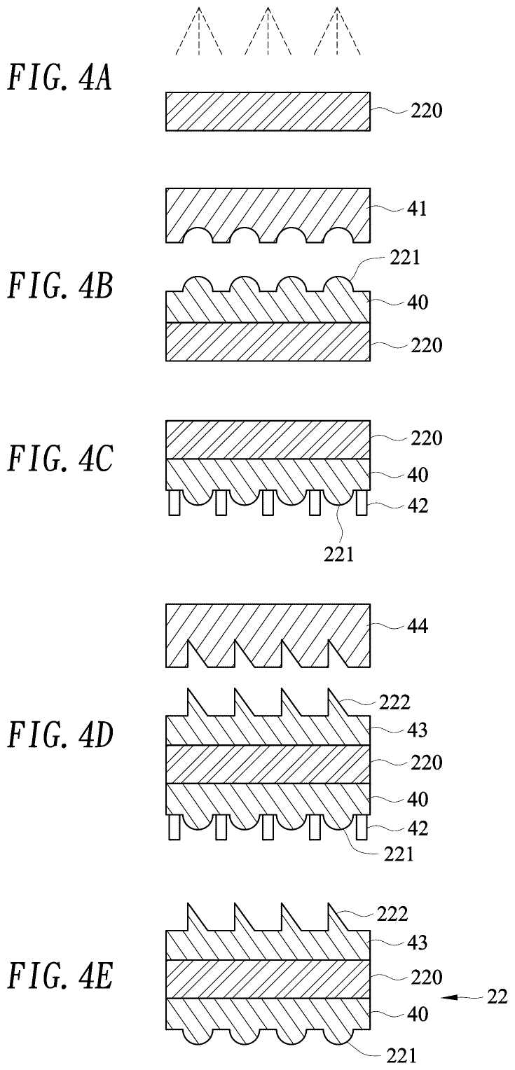

FIG. 4A to FIG. 4E show cross-sectional views illustrating a flow of forming the optical component plate 22 by using nanoimprint lithography (NIL) process according to one embodiment of the present invention. As shown in FIG. 4A, a (second) wafer 220 (e.g., glass) is provided and is then subjected to cleaning. Next, as shown in FIG. 4B, a second imprint resist layer 40 (e.g., monomer or polymer) is formed on a first surface of the (second) wafer 220, and is then subject to imprinting by a lens (i.e., first optical component) working stamp (or template) 41, thereby resulting in the lens 221. A shown in FIG. 4C, the (second) wafer 220 is inverted and is temporarily bonded to a support 42. Subsequently, as shown in FIG. 4D, a third imprint resist layer 43 (e.g., monomer or polymer) is formed on a second surface of the wafer 220, and is then subject to imprinting by a prism (i.e., second optical component) working stamp (or template) 44, thereby resulting in the prisms 222. Finally, as shown in FIG. 4E, the support 42 is removed, thereby resulting in the optical component plate 22. The second/third imprint resist layer 40/43 may be cured by heat or (ultraviolet) UV light during the imprinting.

Nanoimprint lithography (NIL) is a method of fabricating nanometer scale patterns. It is a nanolithography process with low cost, high throughput and high resolution. It creates patterns by mechanical deformation of imprint resist and subsequent processes. According to the NIL process for forming the V-groove plate 21 and the optical component plate 22, high precision pattern transfer with smooth surface can be attained, optical grade material with high transmission optical performance may be used, and is suitable for mass production.

Although specific embodiments have been illustrated and described, it will be appreciated by those skilled in the art that various modifications may be made without departing from the scope of the present invention, which is intended to be limited solely by the appended claims.

What is claimed is:

1. A nanoimprint lithography (NIL) process for forming an optical fiber array, the process comprising:
(a) providing a first wafer;
(b) forming a first imprint resist layer on the first wafer;
(c) subjecting the first imprint resist layer to imprinting by a groove working template, thereby resulting in a groove plate having a plurality of grooves disposed on a top surface thereof;
(d) providing a second wafer;
(e) forming a second imprint resist layer on a first surface of the second wafer;
(f) subjecting the second imprint resist layer to imprinting by a first optical component working template, thereby resulting in a plurality of first optical components disposed on a first surface of an optical component plate;
(g) inverting the second wafer, which is temporarily bonded to a support;
(h) forming a third imprint resist layer on a second surface of the second wafer, the second surface being opposite the first surface; and
(i) subjecting the third imprint resist layer to imprinting by a second optical component working template, thereby resulting in a plurality of second optical components disposed on a second surface of the optical component plate.

2. The process of claim 1, wherein the first wafer and the second wafer comprise glass.

3. The process of claim 1, wherein the first imprint resist layer, the second imprint layer and the third imprint resist layer comprise monomer or polymer.

4. The process of claim 1, further comprising a step before the step (b):
subjecting the first wafer to cleaning.

5. The process of claim 1, wherein the step (c) further comprises:
curing the first imprint resist layer by heat or ultraviolet light.

6. The process of claim 1, further comprising a step before the step (e):
subjecting the second wafer to cleaning.

7. The process of claim 1, further comprising a step after the step (i):
removing the support.

8. The process of claim 1, wherein the step (f) and the step (i) further comprise:
curing the second imprint resist layer and the third imprint resist layer by heat or ultraviolet light.

9. The process of claim 1, wherein the first optical components comprise lens, and the second optical components comprise prisms.
